(19) United States
(12) Patent Application Publication
(10) Pub. No.: US 2025/0258035 A1
(43) Pub. Date: Aug. 14, 2025

(54) LARGE-SCALE ACOUSTIC RECOGNITION SYSTEM

(71) Applicant: NEC Laboratories America, Inc., Princeton, NJ (US)

(72) Inventors: Wataru KOHNO, Princeton, NJ (US); Jian FANG, Princeton, NJ (US); Shuji MURAKAMI, Monmouth Junction, NJ (US); Shaobo HAN, Princeton, NJ (US); Ting WANG, West Windsor, NJ (US)

(73) Assignee: NEC Laboratories America, Inc., Princeton, NJ (US)

(21) Appl. No.: 19/052,465

(22) Filed: Feb. 13, 2025

Related U.S. Application Data
(60) Provisional application No. 63/552,817, filed on Feb. 13, 2024.

(51) Int. Cl. G01H 9/00; G06F 9/451; G06F 16/22

(52) U.S. Cl. CPC G01H 9/004; G06F 9/451; G06F 16/2237

(57) ABSTRACT

Disclosed are integrated DFOS/DAS systems, methods, and structures that employ a large-scale pretrained recognition model we refer to as an “acoustic-language model”, which is pretrained with natural-language supervision (“contrastive language-audio pretraining”. The acoustic-language model comprises two primary components: an acoustic encoder and a text encoder. These encoders are pretrained using a cross-modal approach on a vast dataset of acoustic features (such as images created from log Mel spectrograms) and their corresponding textual captions. When acoustic features and/or languages are input into their respective encoders within the model, they generate corresponding embedding vectors. Both embedding vectors are then linked in a joint multimodal space using linear projections. The acoustic classification tasks using this model are executed by assessing the similarity between the acoustic and language embedding vectors, essentially evaluating the maximum similarity between the acoustic features and the events described in a specific language.

### CROSS-REFERENCE TO RELATED APPLICATIONS

This application claims the benefit of U.S. Provisional Patent Application Ser. No. 63/552,817 filed Feb. 13, 2024, the entire contents of which is incorporated by reference as if set forth at length herein.

### FIELD OF THE INVENTION

This application relates generally to acoustic sensing over large geographic areas. More particularly, it pertains to acoustic sensing using distributed fiber optic sensing (DFOS) systems, methods, structures to provide large-scale acoustic recognition along with generative artificial intelligence (AI) and large language models (LLM).

### BACKGROUND OF THE INVENTION

Distributed Acoustic Sensing (DAS) is a DFOS technology that uses fiber optic cables to detect acoustic vibrations. It has a wide range of applications across various industries due to its unique capabilities:

### Key Utilities and Applications:

Pipeline Monitoring: DAS can detect leaks, third-party interference, and ground movement along pipelines, ensuring safety and preventing environmental damage.
Security and Surveillance: It can monitor perimeters, detect intrusions, and identify unusual activities in critical infrastructure, borders, and other sensitive areas.
Transportation: DAS can monitor the condition of railways, detect track defects, and even track trains in real-time. It can also be used for traffic monitoring and incident detection on roads.
Seismic Monitoring: DAS can be used to study earthquakes, volcanic activity, and other geological phenomena. It can also be used for early warning systems.
Environmental Monitoring: DAS can monitor glaciers, landslides, and other natural hazards. It can also be used to study marine life and other environmental phenomena.
Oil and Gas Industry: DAS can be used for reservoir monitoring, well integrity assessment, and hydraulic fracturing optimization.

### Advantages of DAS:

High Sensitivity: DAS can detect very small vibrations, making it suitable for a wide range of applications.
Long Range: A single DAS system can monitor long stretches of fiber optic cable, making it cost-effective for large-scale deployments.
Real-time Monitoring: DAS provides real-time data, allowing for immediate response to events.
Passive Sensing: DAS does not require any active components in the field, making it reliable and low-maintenance.
Versatility: DAS can be used in a variety of environments, including underground, underwater, and in harsh conditions.

Overall, Distributed Acoustic Sensing is a powerful technology with a wide range of applications. Its ability to detect small vibrations over long distances in real-time makes it a valuable tool for monitoring critical infrastructure, ensuring safety, and protecting the environment.

### SUMMARY OF THE INVENTION

An advance in the art is made according to aspects of the present disclosure directed to integrated DFOS/DAS systems, methods, and structures that employ a large-scale pretrained recognition model we refer to as an “acoustic-language model”, which is pretrained with natural-language supervision (“contrastive language-audio pretraining”.

Viewed from a first aspect, the acoustic-language model comprises two primary components: an acoustic encoder and a text encoder. These encoders are pretrained using a cross-modal approach on a vast dataset of acoustic features (such as images created from log Mel spectrograms) and their corresponding textual captions. When acoustic features and/or languages are input into their respective encoders within the model, they generate corresponding embedding vectors.

Both embedding vectors are then linked in a joint multimodal space using linear projections. The acoustic classification tasks using this model are executed by assessing the similarity between the acoustic and language embedding vectors, essentially evaluating the maximum similarity between the acoustic features and the events described in a specific language. Thus, users can interact with the model using language-based input and design events for classification accordingly.

Additionally, since the acoustic encoder outputs embedding vectors for arbitrary acoustic signals, we can fine-tune the weights of the acoustic encoder using arbitrary audio datasets without captions or event labels for fine-tuning. For example, once background noise data from the actual deployed fiber is collected, adding these noises to arbitrary web-based dry sound sources will create a dataset for fine-tuning the acoustic encoder.

Since this model incorporates a language model to interpret users' requirements, we can enhance the system with minimal effort from the language-model perspective. This is achieved by introducing and optimizing soft prompts for specific domains.

### BRIEF DESCRIPTION OF THE DRAWING

FIG. 1(A) and FIG. 1(B) are schematic diagrams showing an illustrative prior art uncoded and coded DFOS systems.

FIG. 2(A), FIG. 2(B), and FIG. 2(C) are a series a schematic diagrams showing illustrative confusion matrices for event classification under two domains with different combinations according to aspects of the present disclosure.

FIG. 3 is a schematic diagram showing an illustrative architectural structure of systems, methods, and structures according to aspects of the present disclosure.

FIG. 4 is a schematic diagram of an illustrative set of component blocks of systems, methods, and structures according to aspects of the present invention.

FIG. 5 is a schematic diagram showing illustrative data flows of systems, methods, and structures according to aspects of the present disclosure.

FIG. 6 is a schematic diagram showing illustrative optical components of phase-sensitive OTDR, where c represents the speed of light in the optical fiber according to aspects of the present disclosure.

FIG. 7 is a schematic diagram of an illustrative process flow for fine tuning an acoustic encoder according to aspects of the present disclosure.

FIG. 8 is a schematic diagram showing examples of spectrograms using same audio according to aspects of the present disclosure.

FIG. 9(A), FIG. 9(B), FIG. 9(C), and FIG. 9(D) is a series of confusion matrices of acoustic classification using 4 training datasets according to aspects of the present disclosure.

FIG. 10 is a schematic diagram showing an illustrative domain adaption with a vector corrector according to aspects of the present disclosure.

FIG. 11(A) and FIG. 11(B) are plots showing illustrative comparisons of similarities between source and target acoustic embedding vectors across various acoustic events according to aspects of the present disclosure.

FIG. 12 is a schematic diagram of an illustrative operation flow according to aspects of the present disclosure.

FIG. 13 is a schematic diagram of an illustrative example of visualization of event waterfall according to aspects of the present disclosure.

FIG. 14 is a schematic flow diagram of illustrative operation flow according to aspects of the present disclosure.

FIG. 15 is a schematic diagram of an illustrative example of visualization of anomaly waterfall according to aspects of the present disclosure.

FIG. 16 is a schematic diagram of an illustrative example of prompt generation from user's requests according to aspects of the present disclosure.

FIG. 17 is a schematic diagram showing illustrative prompt-tuning based language-model update for generating optimum prompts according to aspects of the present disclosure.

FIG. 18 is a schematic diagram showing illustrative features in hierarchical format according to aspects of the present disclosure.

FIG. 19 is a schematic diagram showing illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

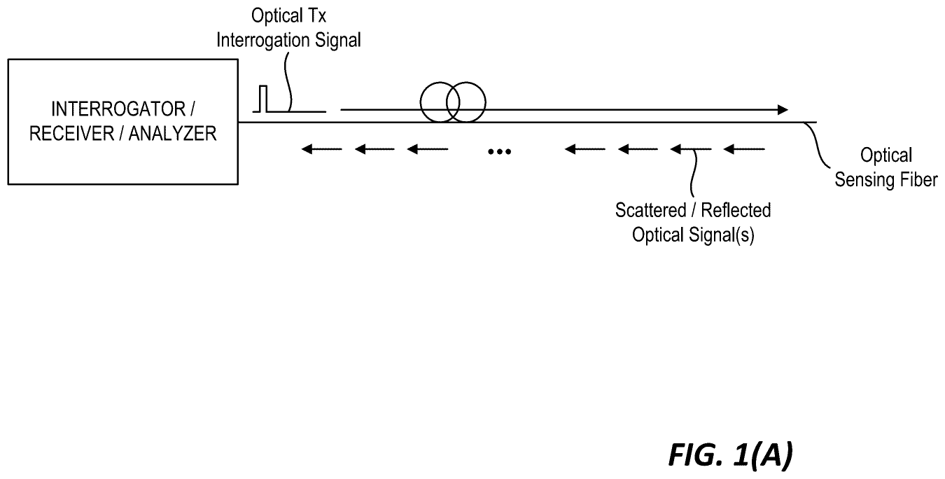

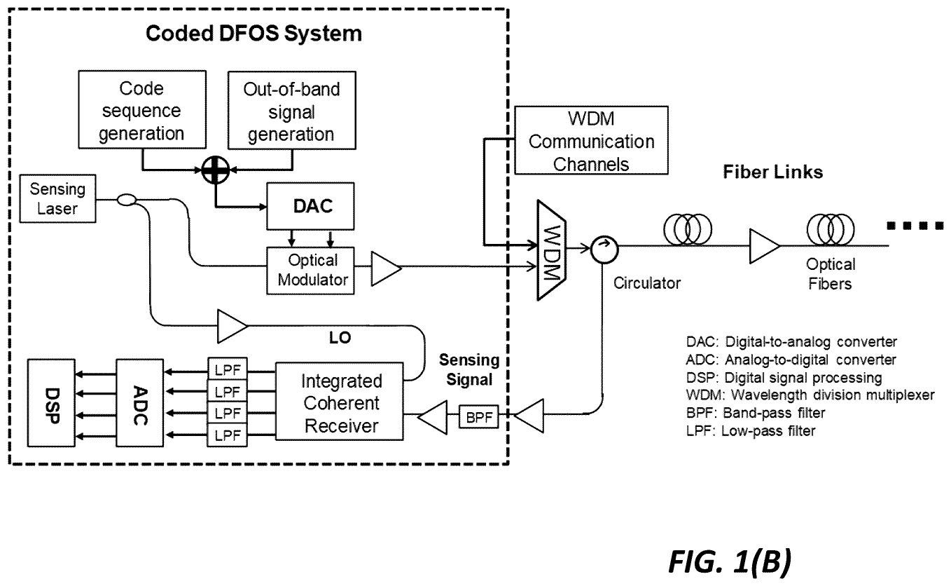

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed temperature sensing systems (DTS) are optoelectronic devices and system which measure temperatures by means of an optical fiber functioning as linear temperature sensors. Temperatures are recorded along the optical sensor cable, thus not at points, but as a continuous profile. A high accuracy of temperature determination may be achieved over great distances.

Typically, contemporary DTS systems can locate the temperature to a spatial resolution of 1 m with accuracy to within ±1° C. at a resolution of 0.01° C. Measurement distances of greater than 30 km can be monitored and some specialized DTS systems can provide even tighter spatial resolutions. Thermal changes along the optical sensor fiber cause a local variation in the refractive index, which in turn leads to the inelastic scattering of the light propagating through it. Heat is held in the form of molecular or lattice vibrations in the material.

Molecular vibrations at high frequencies (10 THz) may be responsible for Raman scattering. Low frequency vibrations (10-30 GHz) may cause Brillouin scattering. Energy is exchanged between the light travelling through the optical sensor fiber and the material itself thereby causing a frequency shift in the incident light. This frequency shift can then be used to measure temperature changes along the fiber.

Physical measurements, such as temperature or pressure and tensile forces, can affect glass fibers and locally change the characteristics of light transmission in the fiber. As a result of the damping of the light in the glass fibers through scattering, the location of an external physical effect can be determined so that the optical fiber can be employed as a linear sensor.

Optical fibers are generally made from doped quartz glass. Quartz glass is a form silicon dioxide (SiO₂) with amorphous solid structure. Thermal effects induce lattice oscillations within the solid.

When light falls onto these thermally excited molecular oscillations, an interaction occurs between the light and the electrons of the molecule. Light scattering, also known as Raman scattering, occurs in the optical fiber. Unlike incident light, this scattered light undergoes a spectral shift by an amount equivalent to the resonance frequency of the lattice oscillation. The light scattered back from the fiber optic therefore contains three different spectral shares: the Rayleigh scattering with the wavelength of the laser source used, the Stokes line components from photons shifted to longer wavelength (lower frequency), and the anti-Stokes line components with photons shifted to shorter wavelength (higher frequency) than the Rayleigh scattering.

The intensity of the so-called anti-Stokes band is temperature-dependent, while the so-called Stokes band is practically independent of temperature. The local temperature of the optical fiber is derived from the ratio of the anti-Stokes and Stokes light intensities.

There are two basic principles of measurement for distributed fiber optic sensing technology, Optical Time-Domain Reflectometry (OTDR) and Optical Frequency-Domain Reflectometry (OFDR). For distributed temperature sensing often a code correlation technology is employed which carries elements from both principles.

OTDR has become the industry standard for telecom loss measurements which detects the—compared to Raman signal very dominant—Rayleigh backscattering signals. The principle for OTDR is quite simple and is very similar to the time-of-flight measurement used for radar.

Essentially a narrow pulse of laser light generated either by semiconductor or solid-state lasers is introduced into the optical sensing fiber and backscattered light is analyzed. From the time it takes the backscattered light to return to a detection unit it is possible to locate the location of the temperature event.

Alternative DTS evaluation units deploy the method of Optical Frequency Domain Reflectometry—OFDR. The OFDR system provides information on the local characteristic only when the backscatter signal detected during the entire measurement time is measured as a function of frequency in a complex fashion and then subjected to Fourier transformation. The essential principles of OFDR technology are the quasi-continuous wave mode employed by the laser and the narrow-band detection of the optical backscatter signal. This is offset by the technically difficult measurement of the Raman scattered light and rather complex signal processing, due to the FFT calculation with higher linearity requirements for the electronic components.

Code Correlation DTS sends on/off sequences of limited length into the fiber. The codes are chosen to have suitable properties, e.g. binary Golay code. In contrast to OTDR technology, optical energy is spread over a code rather than packed into a single pulse. Thus, a light source with lower peak power compared to OTDR technology can be used, e.g. long-life compact semiconductor lasers. The detected backscatter needs to be transformed-like OFDR technology-back into a spatial profile, e.g. by cross-correlation. In contrast to OFDR technology, the emission is finite (for example 128 bit) which avoids that weak scattered signals from far are superposed by strong scattered signals from short distance, improving the Shot noise and the signal-to-noise ratio.

Using these techniques it is possible to analyse distances of greater than 30 km from one system and to measure temperature resolutions of less than 0.01° C.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DTS/DAS/DVS technologies have a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter, requiring only one battery per sensor. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over large areas using the optical fiber. However, there are notable concerns with recording large-scale audio data as follows.

Large data storage: Audio is a dense time series data form that demands significant storage. For example, recording monophonic audio at a 48 kHz sampling rate and 16-bit depth requires approximately 5.76 megabytes per minute. Monitoring with a DAS over 2,000 sensing points could exceed 1 terabyte in just 2 hours.

Data privacy: Audio data can sometimes include private conversations. Recording audio without consent in areas near audio devices or optical fibers connected to the sensor box could be considered wiretapping. It is crucial to be vigilant about data privacy issues. To safeguard privacy, specific audio signals should be detected and filtered out.

Addressing these concerns, an acoustic recognition model can be an effective solution for both data compression and privacy issues. By categorizing audio data into several events within a given timeframe, we can compress the data while preserving essential event information as a function of time and sensing-point locations. It also enables selective recording of audio data based on event type which is expected to reduce the data storage dramatically. However, constructing acoustic recognition models for DAS data presents challenges as follows.

Event Class and Corresponding Model Definition for Each User: DAS users have diverse requirements. For instance, a user might utilize a submarine cable for underwater surveillance. To cater to the varied needs of different users, we can either develop a large-scale recognition model based on an extensive dataset or create specific models tailored to user-defined event classes. The former approach entails covering all possible event classes for all users, which is a challenging task, particularly in differentiating acoustically similar yet irrelevant events. In the latter approach, users are required to: (1) define the events they wish to recognize, (2) prepare a specific dataset for these events, and (3) construct a recognition model by training with this dataset. After building the model, if users wish to recognize additional acoustic events, they must incorporate the corresponding event dataset and retrain the model.

Distribution shift due to fiber environment/deployment differences: Users generally have varied fiber environments, leading to substantial differences in frequency responses and background noises in DAS data. When the conditions of the fiber in the training phase (source domains) differ from those in the application phase (target domains), these variations can impact recognition accuracy due to distribution shifts.

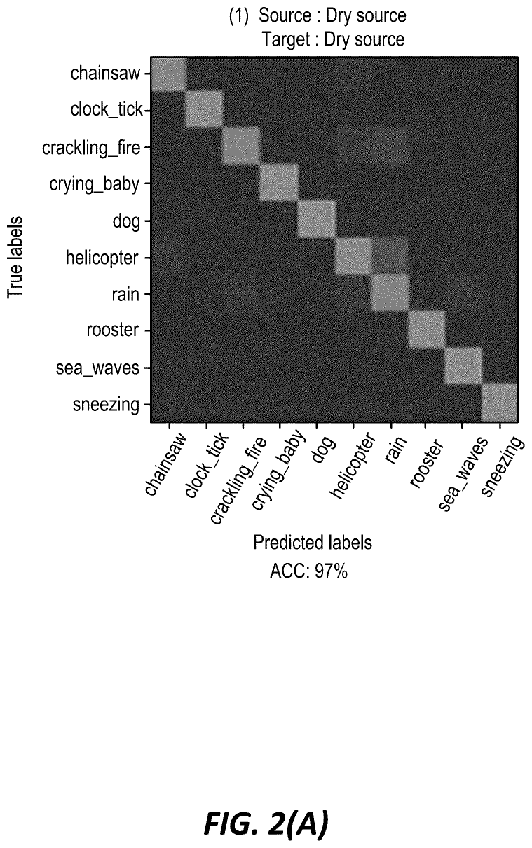

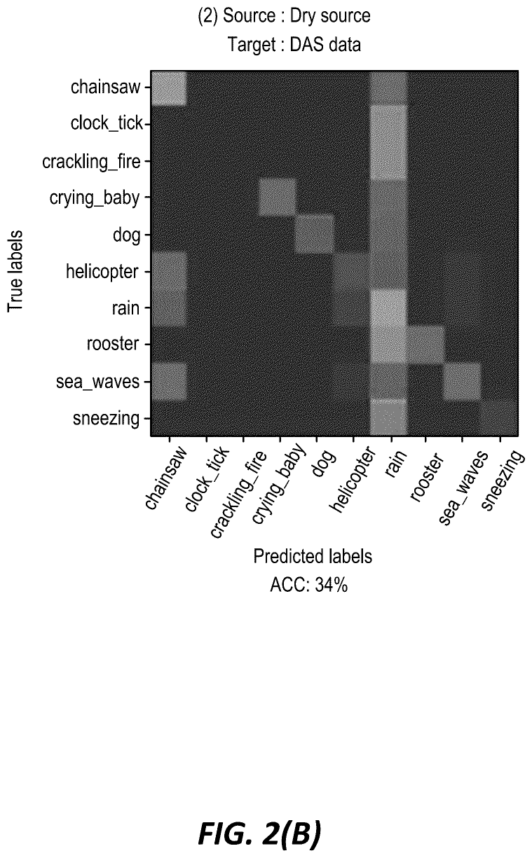

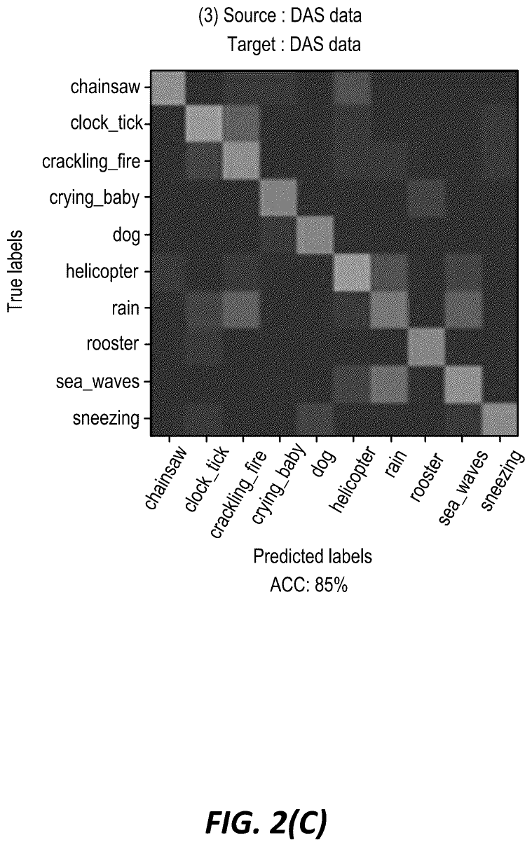

FIG. 2(A), FIG. 2(B), and FIG. 2(C) are a series a schematic diagrams showing illustrative confusion matrices for event classification under two domains with different combinations according to aspects of the present disclosure.

As illustratively depicted, these figures show simple examples for acoustic classification using different conditions using confusion matrices, i.e., (1) finetunes on dry sources recorded by electric microphone and tested on dry sources, (2) finetunes on dry sources and tested on DAS data, and (3) fine-tunes on DAS data and tested on DAS data. While (1) are (3), which are finetuned in the same domains, show diagonal confusion matrices with relatively high accuracies, (2) tends to recognize most of events as “rain” because of the characteristic background noise in DAS and shows substantially low accuracy as a result. To mitigate this type of issue, model fine-tuning with labeled data collected in the target environment is necessary.

According to aspects of the present disclosure, we introduce a solution featuring a large-scale pretrained recognition model, which we refer to as the “acoustic-language model” in this document. The method of acoustic pretraining with natural-language supervision is termed “contrastive language-audio pretraining”. The acoustic-language model comprises two primary components: an acoustic encoder and a text encoder. These encoders are pretrained using a cross-modal approach on a vast dataset of acoustic features (such as images created from log Mel spectrograms) and their corresponding textual captions. When acoustic features and/or language s are input into their respective encoders within the model, they generate corresponding embedding vectors.

Both embedding vectors are then linked in a joint multimodal space using linear projections. The acoustic classification tasks using this model are executed by assessing the similarity between the acoustic and language embedding vectors, essentially evaluating the maximum similarity between the acoustic features and the events described in a specific language. Thus, users can interact with the model using language-based input and design events for classification accordingly. Additionally, since the acoustic encoder outputs embedding vectors for arbitrary acoustic signals, we can fine-tune the weights of the acoustic encoder using arbitrary audio datasets without captions or event labels for fine-tuning. For example, once background noise data from the actual deployed fiber is collected, adding these noises to arbitrary web-based dry sound sources will create a dataset for fine-tuning the acoustic encoder.

Since this model incorporates a language model to interpret users' requirements, we can enhance the system with minimal effort from the language-model perspective. This is achieved by introducing and optimizing soft prompts for specific domains.

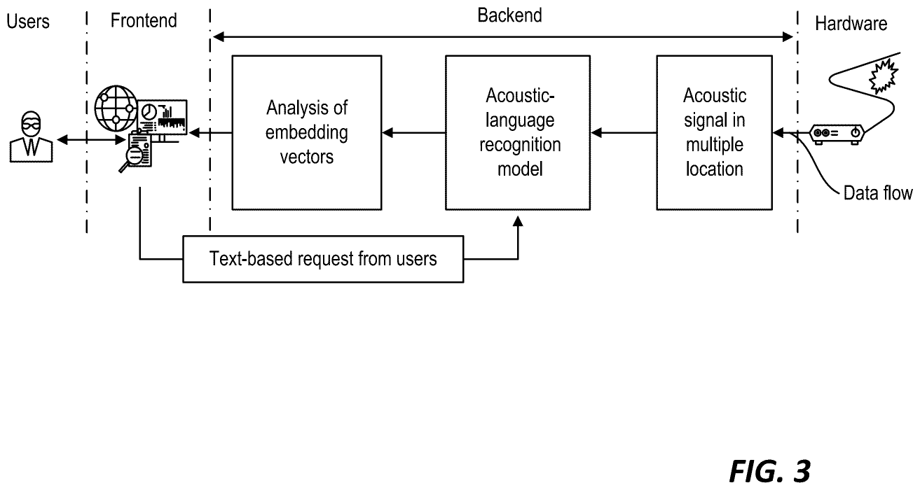

FIG. 3 is a schematic diagram showing an illustrative architectural structure of systems, methods, and structures according to aspects of the present disclosure.

By integrating a recognition model and a corresponding language-based interactive interface into the DAS system, which functions as an extensive acoustic sensor array, it is possible to develop a comprehensive system for acoustic event/scene recognition. This system is characterized by its large scale, flexibility in terms of recognition task designs, and the facility for straightforward updates to the acoustic model without labels

As will become apparent to those skilled in the art, our inventive disclosure can address issues as follows:

Conversion of audio data into embedding vectors through data compression: The acoustic encoder transforms audio data into an embedding vector. Considering a 2-second audio clip with a 48 kHz sampling rate, when it's converted into an embedding vector comprising 1000 components, the data undergoes effective down sampling. This results in a reduction to approximately 1/100th of the original data size in terms of storage requirements.

Privacy protection by embedding vectors: While raw audio data can be hearable, the audio embedding vector is difficult to read without using the text encoder trained with the acoustic encoder. It is secure for users once the audio data is transformed into vector format with the model.

Flexible usability for acoustic event recognition: Users have the flexibility to define and design the acoustic events they need to recognize using a language-based interface. The model evaluates the similarities between language embedding vectors, which are calculated from users' prompts, and acoustic embedding vectors. Consequently, the model can infer an event based on similarity if the recorded acoustic signal encompasses features learned from the dataset, and if the target event conceptually resembles the recorded feature.

Model transfer without labels or captions: Beyond the features described earlier, the acoustic encoder can be fine-tuned without the need for labels or captions. This is achievable by utilizing arbitrary web-based sound datasets along with certain physical conditions of the sensors deployed in real environments, such as background noise, impulse responses, and so on.

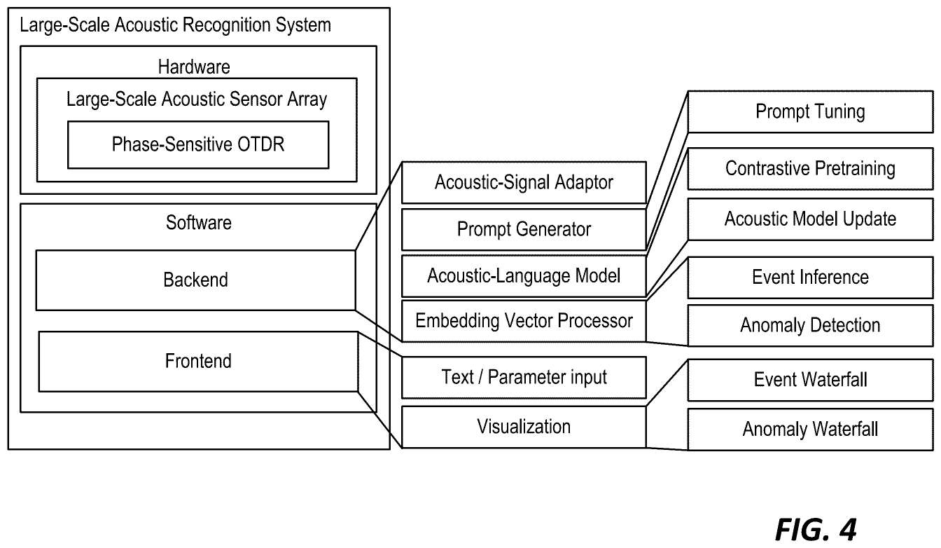

FIG. 4 is a schematic diagram of an illustrative set of component blocks of systems, methods, and structures according to aspects of the present invention, which we have illustratively named “large-scale acoustic recognition system”.

Our large scale acoustic recognition system comprises hardware (large-scale acoustic device such a phase-sensitive OTDR) and software (backend including the acoustic-language model and frontend including text/parameter input).

Main components of this system include:

Hardware for acoustic signal collection (Phase-sensitive OTDR): This involves Distributed Acoustic Sensors (DAS) capable of simultaneously collecting acoustic signals from multiple locations as raw signals.

Signal preprocessors: These are used for processing raw signals and include frequency filters, denoisers, and frequency-response correction tools (signal corrector). The preprocessed signals are converted into acoustic features (feature extractor).

Acoustic-language model: Acoustic encoder and text encoder which are pretrained in cross-modal manner are included. It is designed for recognizing acoustic features based on the prompts that are input. The model parameters in the acoustic encoder can be updated to adapt to certain domain by using arbitrary web-based sound datasets with recorded noise or/and impulse information.

Vector database for post processing embedding vectors (Embedding vector processor): This processes the embedding vectors generated by the model, such as similarity evaluation between embedded vectors. The processed data is displayed on the graphical user interface. At the same time, the embedding vectors are stored as a log data here.

Graphical user interface: A user-friendly interface enabling text input into the acoustic-language model via various methods such as chat boxes, text boxes, and event-class editors. It also allows for the adjustment of physical parameters in the hardware and displays the outcomes of the recognition process.

Prompt Generator: This component converts user-provided text information into correctly formatted prompts for input into the acoustic-language model. Language models, such as Generative Pre-trained Transformers (GPT), are utilized to interpret users' requests and transform them into the appropriate format. It also has the feature for tuning prompts with soft prompts to generate optimal prompts in specific domains or environments.

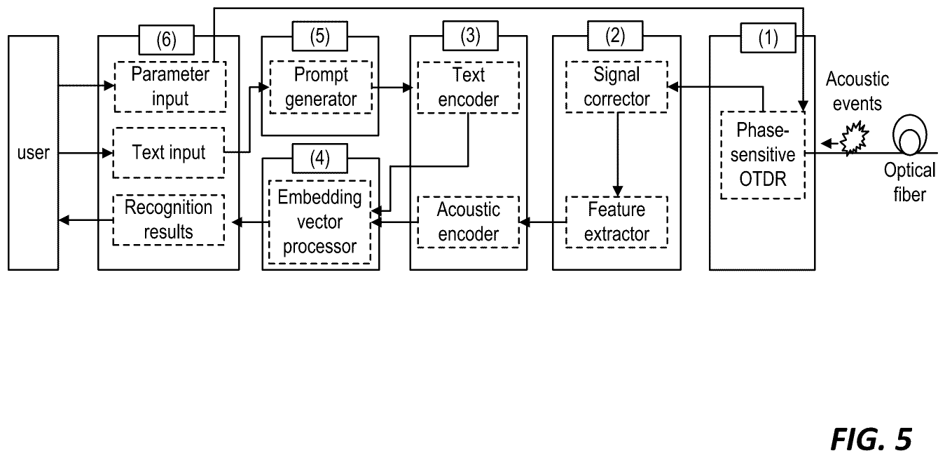

FIG. 5 is a schematic diagram showing illustrative data flows of systems, methods, and structures according to aspects of the present disclosure.

Shown in this figure is a typical data flow in our solution, showing the relationship between users and the invention's components, with arrow directions indicating the general data flow.

The overall steps are summarized in this figure, A detailed description is as follows:

### (1-1) Acoustic Event Detection by Phase Sensitive OTDR.

To achieve acoustic detection in large areas, we employ a distributed fiber-optic sensing scheme. As acoustic signals induce dynamic strain on an optical fiber, an interrogator connected to the fiber detects these changes using optical methods. Specifically, a Distributed Acoustic Sensor (DAS) based on phase-sensitive Optical Time-Domain Reflectometry (OTDR) translates the dynamic strain in the optical fiber into phase changes of Rayleigh backscattered light.

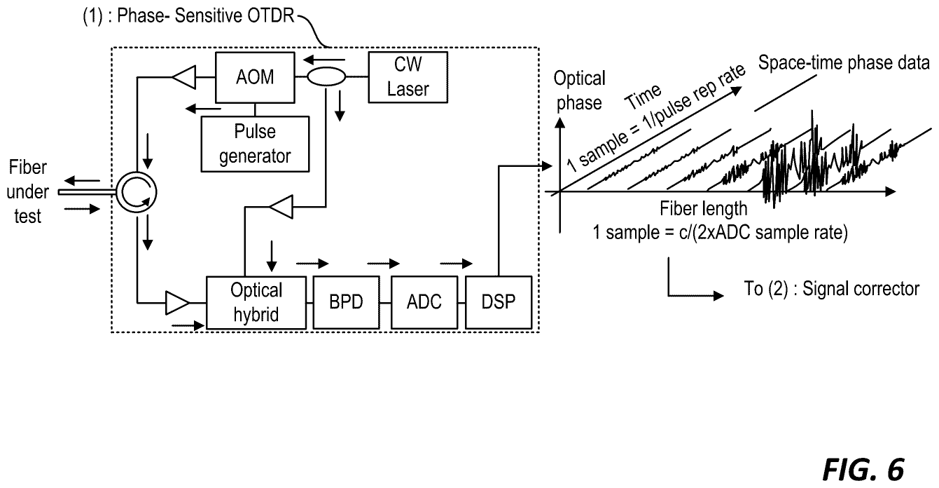

FIG. 6 is a schematic diagram showing illustrative optical components of phase-sensitive OTDR, where c represents the speed of light in the optical fiber according to aspects of the present disclosure.

The interrogator connected to the fiber under test comprises a coherent laser source, an optical coupler, an optical hybrid, a modulator (such as an acousto-optic modulator (AOM) with a pulse generator), an optical amplifier (like an Erbium-doped fiber amplifier (EDFA)), a circulator, a photodetector (such as a balanced photo detector (BPD)), analog-to-digital converters (ADC), and digital signal processing (DSP) unit.

The coherent laser is split into two beams. One beam is shaped into pulses and repeatedly transmitted into the fiber under test, with the pulse repetition rate corresponding to the sampling rate of the detected optical phase. Once the optical pulse is transmitted, Rayleigh scattering is induced in every portion of the fiber under test in random locations and backscattered towards the interrogator through the circulator into the optical hybrid. The other component of the split coherent laser, combined with the backscattered light through heterodyne or homodyne detection scheme, enables the BPD to convert the beating signals into electrical signals. Then, the ADC digitizes these signals, where the half of inverse of the ADC's sampling rate F_{ADC} determines the distance between spatial sensing points in the fiber as c/2F_{ADC}, where c represents the speed of light in the optical fiber. The digitized signal is processed by the DSP, and then the differential phase over a certain distance, defined as the gauge length, is reconstructed as space-time phase data. This space-time phase data will be further processed in the subsequent step for acoustic-signal recognition.

### (2-1) Signal Processing in Signal Corrector.

In the raw phase signals of fiber sensing, various background noises unassociated with acoustic events are detected, including Gaussian white noise and stationary background vibrations.

Particularly notable is the scenario in which the intensity of backscattered light significantly diminishes due to destructive interference among random Rayleigh scatterers within the optical fiber, a condition known as Rayleigh fading. This phenomenon, occurring non-stationarily, results in noisy phase data.

Additionally, the frequency responses of the fiber dynamic strain will differ with each fiber deployment.

To remove these artifacts, frequency filtering such as high-pass filtering, denoising such as spectral gating, and frequency-response correction are applied to raw phase signals.

### (2-2) Feature Extraction.

After filtering the signal, the phase signals are transformed into a set of acoustic features, such as log Mel spectrograms. When using log Mel spectrograms, consistent parameters are employed, including hop size, window size, and the number of Mel bins. These acoustic features are then input into the acoustic encoder in the acoustic-language model.

### (3-1) Acoustic-Feature Encoding to Produce Embedding Vectors.

A pretrained acoustic encoder's role is to transform a set of acoustic features into a set of embedding vectors represented in the multimodal space. Due to its deep neural network (DNN) structure, a large-scale audio classification model with high performance, such as PANNS-CNN14 or HTS-AT, is typically used. The classification layer in these models is replaced with a layer that outputs vectors for acoustic encoding. These encoded vectors are then projected into the vectors in the multimodal space using a linear projection, which we refer to as the acoustic embedding vectors. The acoustic embedding vectors are outputted into the embedding vector processor.

### (3-2) Prompt Encoding to Produce Embedding Vectors.

Prompts are input into the pretrained text encoder from the prompt generator, as described in (6-1-1) or (6-1-2). The text encoder utilizes a large-scale deep neural network (DNN) structure, such as Hugging Face's transformer model. The vectors encoded by the text encoder are then projected into vectors in the multimodal space using a linear projection, referred to as the language embedding vectors. These language embedding vectors are output to the embedding vector processor in the same manner as the acoustic embedding vectors.

### (3-3-1) Model Weight Updates for Acoustic Encoder.

Since we initially applied a pretrained model based on web datasets collected from electric microphones to real environments, significant domain gaps are expected between the source data (electric microphone data) and the target data (collected optical phase signals). With the acoustic encoder in the acoustic-language model, we can transform arbitrary preprocessed phase signals into embedding vectors that characterize acoustic scenes or events. In other words, we can retrain the acoustic encoder without introducing language-based information, similarly to the method of knowledge distillation, and fine-tune it on a specific domain of recording data.

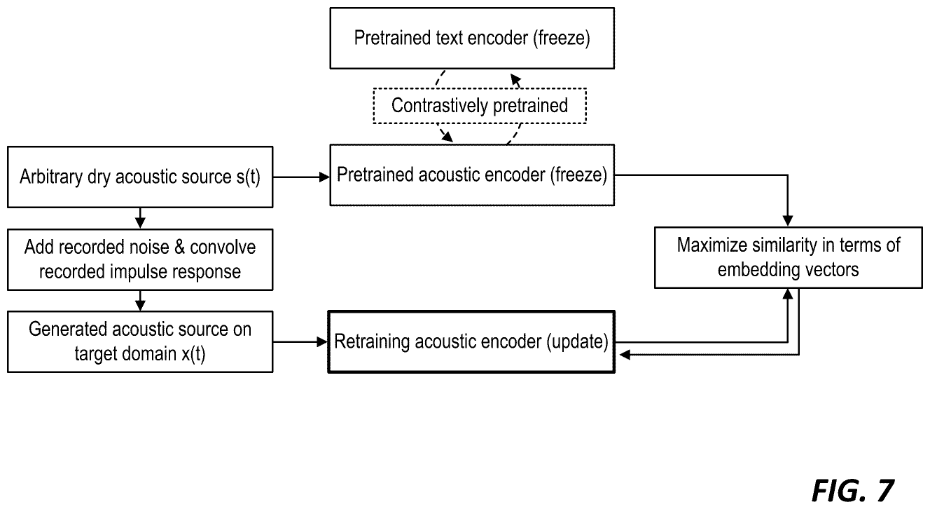

FIG. 7 is a schematic diagram of an illustrative process flow for fine tuning an acoustic encoder according to aspects of the present disclosure. The procedure is illustrated as follows:

Prepare arbitrary dry acoustic source recorded by electric microphones, such as web datasets. We don't need to apply any captions or labels on the data. We here define one of the sources as s(t).

Record the background noise n(t) and impulse response h(t) in the target domain.

Generate a corresponding acoustic source dataset with adding the recorded noise and convolving the recorded impulse response on the dry acoustic sources, following x(t)=s(t)⊗h(t)+An(t), where A is the parameter to control signal-to-noise ratio.

Copy the pretrained acoustic encoder (or preparing an acoustic encoder with smaller parameters) as another encoder for finetuning.

Train the copied model with freezing the original encoder, by inputting x(t) and s(t), respectively. Note that the parameters in the encoder for finetuning are updated based on the back propagation from the loss function which maximize the similarity between two embedding vectors from two acoustic encoders obtained from x(t) and s(t).

A key aspect of the fine-tuning procedures is our capability to generate and utilize various acoustic datasets, which include physical information recorded in the target domain. This is because we retrain by comparing two acoustic signals based on their acoustic embedding vectors, instead of relying on natural-language supervision.

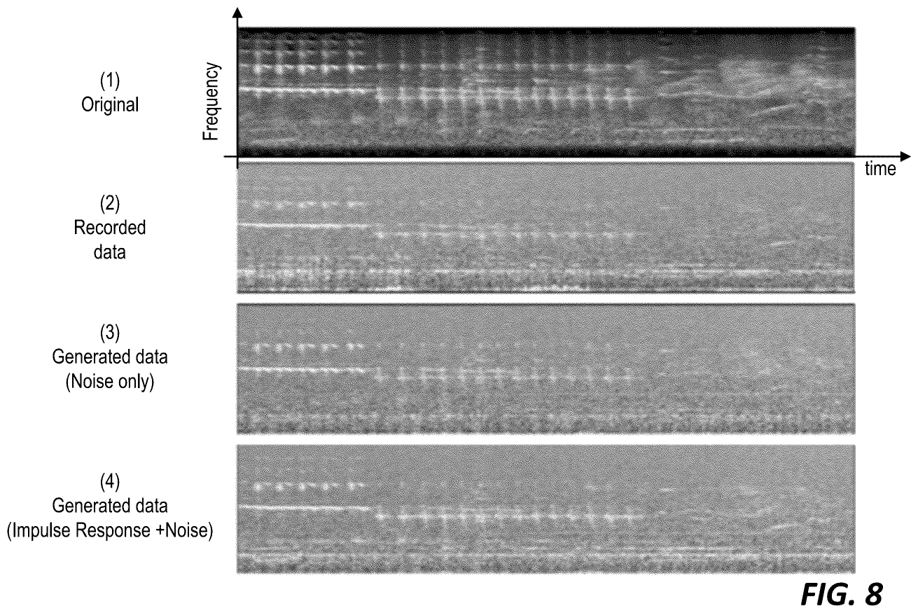

FIG. 8 is a schematic diagram showing examples of spectrograms using same audio according to aspects of the present disclosure. As may be observed, this figure presents four spectrogram examples (power spectrum in frequency and time) from a single audio recording (a bird-chirping signal lasting 5 seconds): (1) is the original data, (2) data recorded by a fiber sensor in a specific deployment, (3) data generated by adding background noise to the original, and (4) data produced by adding both noise and impulse-response convolution. Notable visual differences exist between (1) and (2), yet (3) and (4) increasingly resemble (2), thanks to the integration of partial physical information. As background noise can be easily collected from ambient states, its incorporation into the signal is straightforward. The impulse response, which characterizes the acoustic properties like frequency response and reverberation/echo, can also be collected with relatively less effort than recording the entire dataset once we obtain a recording of sinusoidal sweep signals.

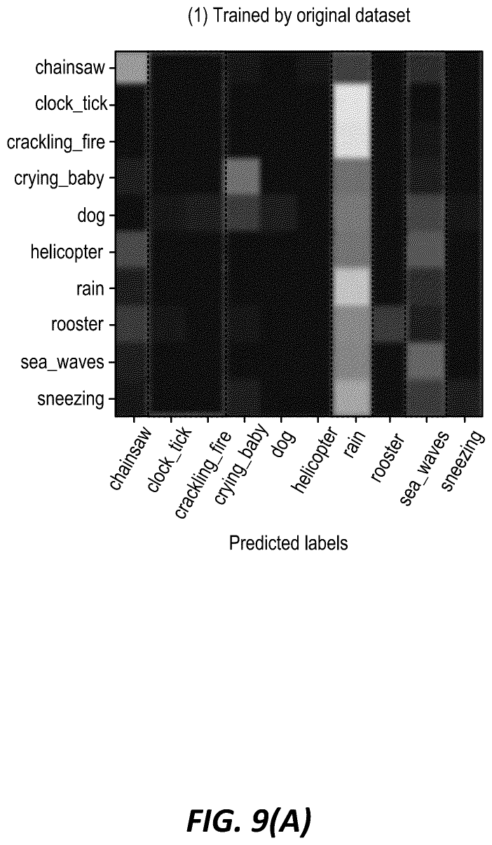

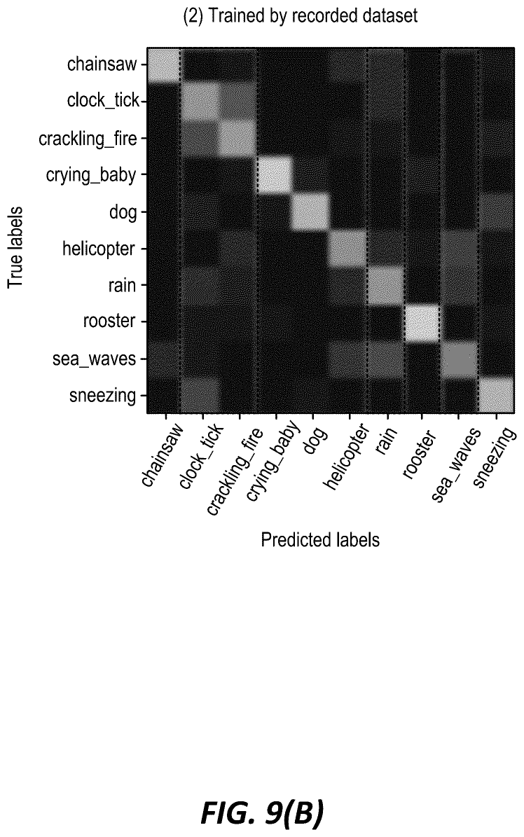

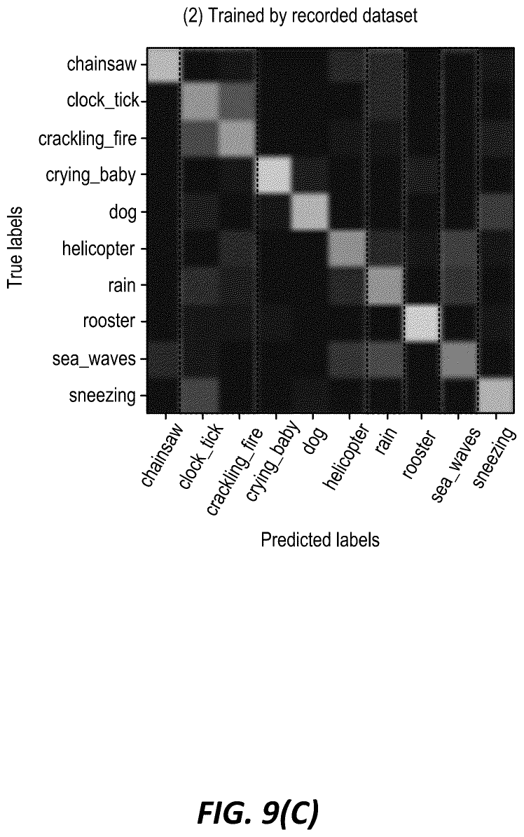

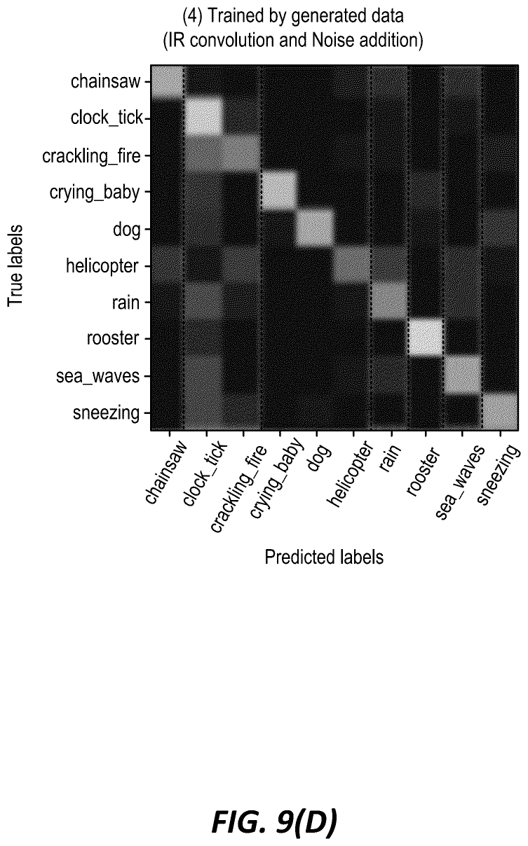

FIG. 9(A), FIG. 9(B), FIG. 9(C), and FIG. 9(D) is a series of confusion matrices of acoustic classification using 4 training datasets according to aspects of the present disclosure. The acoustic classification results are of a recorded dataset (10 classes) by DAS, using models fine-tuned on the four acoustic datasets described previously. The initial result shows a clear distribution shift. However, the matrices obtained based on generated datasets like (3) and (4) are more diagonal, indicating a recovery in the distribution shift. When comparing (3) and (4), the most notable difference is observed in the accuracy of the “rain” event classification, where (4) demonstrates enhanced capability in distinguishing characteristic noises in DAS from the actual acoustic events. Thus, the generative method will play the role to recover the distribution shift.

After updating the acoustic encoder using the method described above, we insert the finetuned acoustic encoder into the same position as the original acoustic encoder.

### (3-3-2) Embedding Vector Correction for Simpler Model Update.

In (3-3-1), we emphasize the retraining function for encoder itself without using caption information. On the other hand, since acoustic features are transformed into vectors, we can also introduce a simpler way with a “vector corrector” for adapting in specific domains or environments in users without changing model weights in the pretrained acoustic encoder.

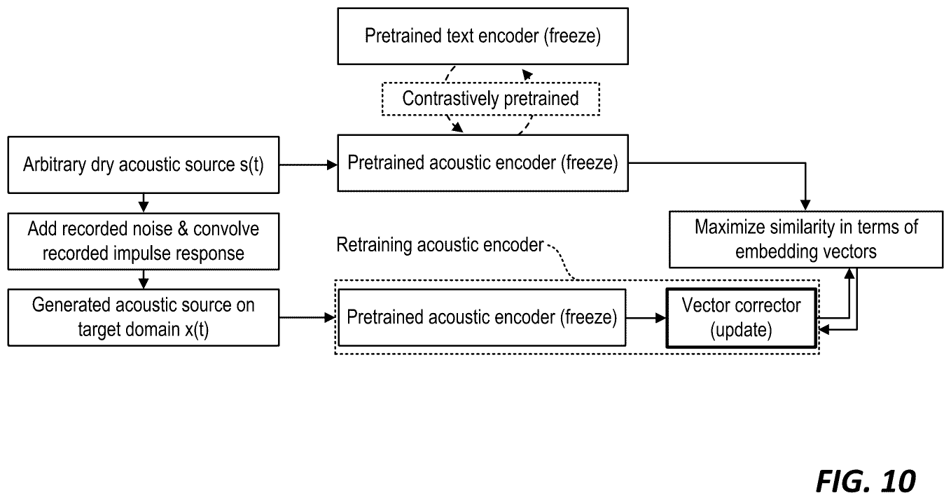

FIG. 10 is a schematic diagram showing an illustrative domain adaption with a vector corrector according to aspects of the present disclosure. This figure shows another process for tuning the acoustic model with the vector corrector. Once we have a pair of acoustic embedding vectors, i.e., generated from a dry source and a generated source, the transformation from the vector by the generated source eₓ to the one by dry source eₛ can be considered. Therefore, by introducing a light DNN model for eₓ→eₛ and implementing it at the tail of the pretrained acoustic encoder, the distribution shift due to the domain difference can be mitigated. In addition, this scheme doesn't require a computational resource compared to the one in (3-3-1).

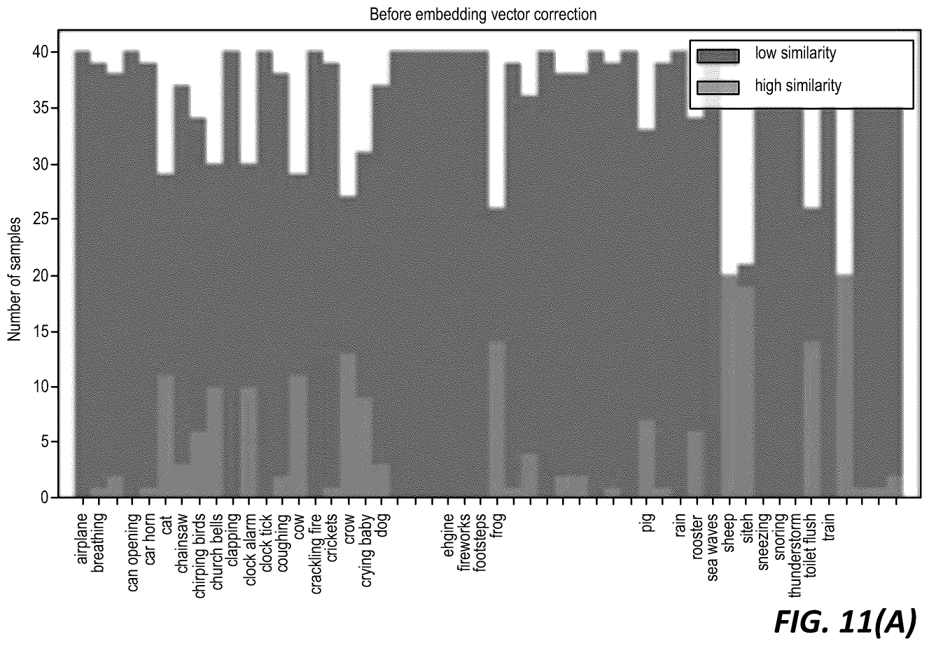

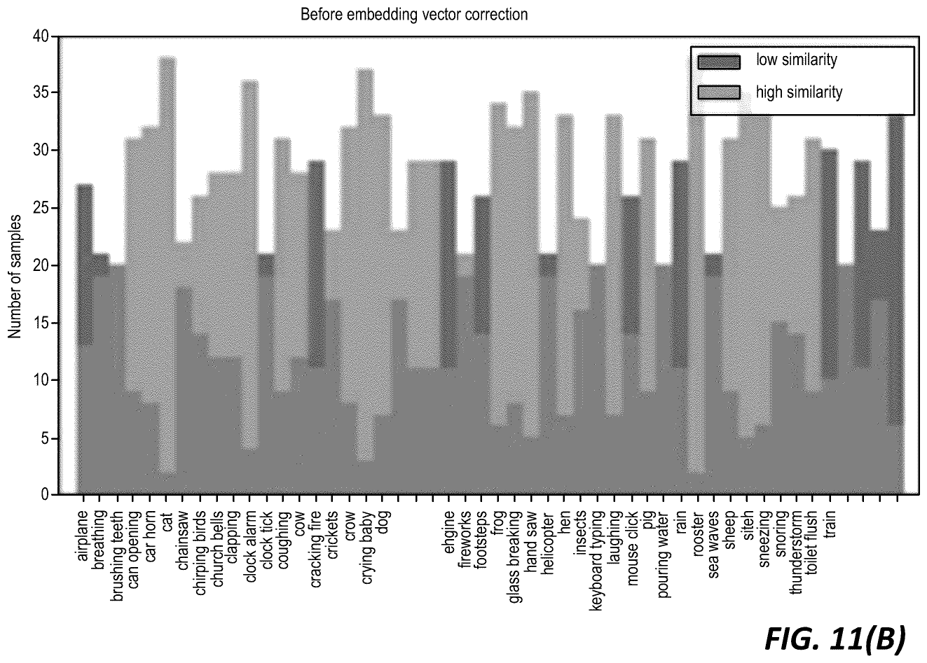

FIG. 11(A) and FIG. 11(B) are plots showing illustrative comparisons of similarities between source and target acoustic embedding vectors across various acoustic events according to aspects of the present disclosure. As illustratively shown, this figure displays the effectiveness of embedding vector correction on 2000 acoustic features within a dataset that includes 50 events, each with 40 samples, by visualizing the similarities between source and target acoustic embedding vectors. The FIG. 11(A) and FIG. 11(B) figures show the counts of low (blue bar) and high (orange bar) similarity samples, both before and after vector correction, while maintaining the same threshold for cosine similarities in all instances. This correction is achieved using an auto-encoder-based DNN structure. The left image distinctly reveals the separation of embedding vectors in terms of similarities in each event, i.e., large similarity distances between source and target embedding vectors. By applying the vector corrector, which aims to transform the target embedding vectors into the source ones with generated data in the way of (3-1-1), we clearly see the similarity distance between target and source becomes smaller in almost all acoustic events and as a result the distribution shift due to the domain difference is mitigated.

### (4-1-1) Embedding Vector Processing for Event Prediction.

As described in (3-1), the acoustic features in certain time frame are transformed into a set of acoustic embedding vectors. At the same time, as described in (3-2), we also have a set of language embedding vectors for event prediction. Assuming there are N event class labels and M sensing points (i.e., length of the fiber for sensing), the embedding vectors outputted by the language and acoustic encoders, derived separately from a prompt describing the i-th class label and from phase data at the j-th sensing point, are denoted as e_{C}_{ᵢ}∈ [symbol] ^{d} and e_{A}_{ᵢ}∈ [symbol] ^{d}r respectively. In this context, d represents the dimension of the embedding vectors, Cᵢ (where integer i∈[1,N]) corresponds to the i-th class label, and Aⱼ (where integer j∈[1, M]) corresponds to the acoustic feature of the j-th sensing point. Under these notations, the cosine similarity between these two vectors is described as Sᵢⱼ≡e_{C}_{ᵢ} e_{A}_{ᵢ}/|e_{C}_{ᵢ}∥e_{A}_{ⱼ}|, i.e., Sᵢⱼ∈[−1,1], where the maximum (minimum) similarity is corresponding to 1 (−1). Taking the argument of the maximum of Sᵢⱼ as

$${σ}_{j} ≡ {arg max}_{i ∈ [ 1 , N ]} {S}_{ij} ,$$

we obtain a vector denoting event-class prediction results with respect to different sensing points.

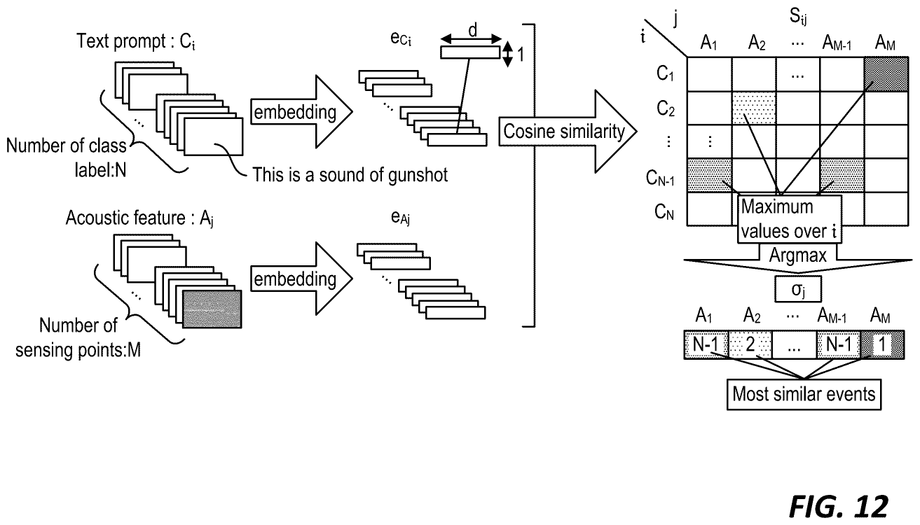

FIG. 12 is a schematic diagram of an illustrative operation flow according to aspects of the present disclosure.

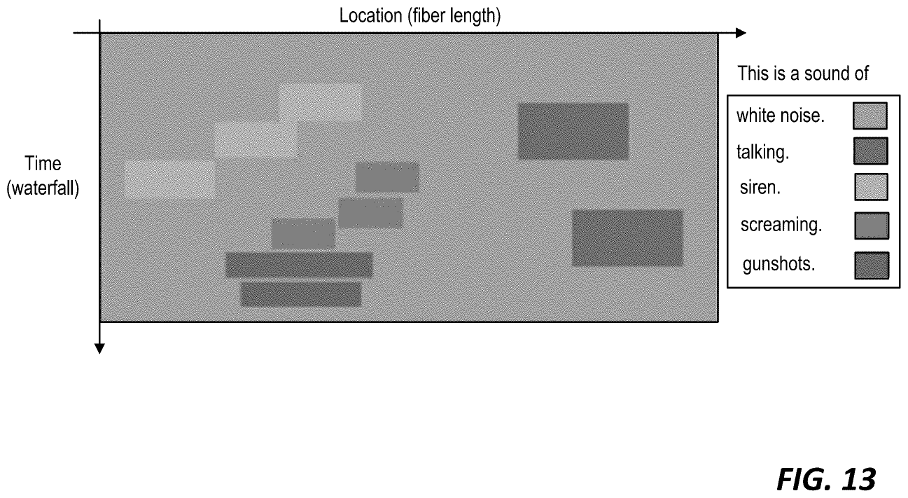

By processing of σⱼ, which involves combining information at different times, and expressing the results as a colored image as depicted in FIG. 13, which is a schematic diagram of an illustrative example of visualization of event waterfall according to aspects of the present disclosure.

From this figure, we can clearly identify the types of acoustic events occurring, ascertain when these events happen, and determine the location of the sound source along the fiber length. In this document, we define this prediction-result visualization as “event waterfall”. With this manner, the raw phase data is densely compressed into the event information. Also, thanks to the feature of acoustic-language model, we can freely change or define the event classes to detect in real time without modifying the recognition model itself. The spatial information will not only inform us the location, but also represents the “loudness” or “impact” of acoustic events in terms of the signal spread along the fiber length.

### (4-1-2) Embedding Vector Processing for Anomaly Detection.

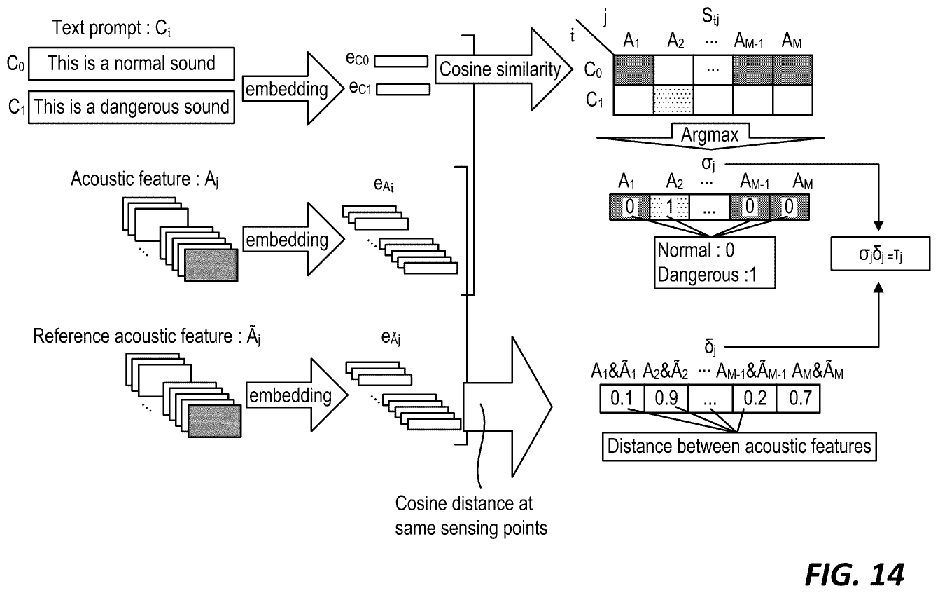

In a manner akin to (4-1-1), we can introduce an index for detecting anomalous acoustics. Imagine a scenario like (4-1-1), but with only two prompts to discern whether an acoustic signal contains dangerous sounds, for example, a prompt such as “this is a normal/dangerous sound.” In this situation, the components of σⱼ are binarized into two categories: normal=0 and dangerous=1. Additionally, by utilizing acoustic features at different times A₁, which include only background noises without any dangerous events (i.e., the ambient state), we can introduce another vector with the cosine-similarity distance as δⱼ≡1−e_{A}_{ⱼ}−e_{Ā}_{ⱼ}/|e_{A}_{ⱼ}∥e_{Ā}_{ⱼ}|, where e_{Ā}_{ⱼ}∈ [symbol] ^{d} is another embedding vector obtained from the acoustic encoder given by A. The distance δⱼ indicates “how different” the current acoustic data is from that in the ambient state. By multiplying σⱼ and δⱼ to form τⱼ≡σⱼδⱼ, we can display a measure that informs us whether the signal is dangerous or not, and simultaneously how distinct the sound is from the ambient state. The overall operation flow is described in FIG. 14, which is a schematic flow diagram of illustrative operation flow according to aspects of the present disclosure.

By processing 8j, which includes combining information from different times, and representing the results as an image as shown in FIG. 14, we can determine whether any dangerous events are occurring, assess how distinct the sound is from the ambient state, and locate the sound source along the fiber length. In this document, we refer to this visualization method as an “anomaly waterfall.” Through this approach, the raw phase data is efficiently compressed into event information. While the method described in (4-1-1) offers a clearer understanding of “what is happening” from the sensing data, this technique can encompass a broader range of “anomaly events,” summarizing them under a single label such as “dangerous,” and indicating the degree of danger associated with the event. If an event is classified as “normal,” the index will not indicate anything, even if the sound is loud and different from the ambient state. It's important to note that this scheme can be enhanced with similar multiple nuances to achieve higher accuracy, for example, by using combinations like normal/dangerous & normal/threatening.

### 5-1) Language-Based Request Form Including Parameter Settings for DAS.

To generate prompts for input into the text encoder, source texts that describe users' requirements are necessary. To facilitate this, the GUI features a form for inputting text information. Once texts are submitted through the form, the prompt generator processes them to create a suitable prompt for the text encoder. Additionally, the GUI includes a form for setting DAS parameters, such as pulse width, gauge length, pulse repetition rate, and others.

### (5-2) Visualization of the Results

Based on the results such that FIG. 11 in (4-1-1) or FIG. 13 in (4-1-2), the GUI visualize the analysis results in real time.

(6-1-1) Language Model for Converting User-Provided Information into Correct Prompts.

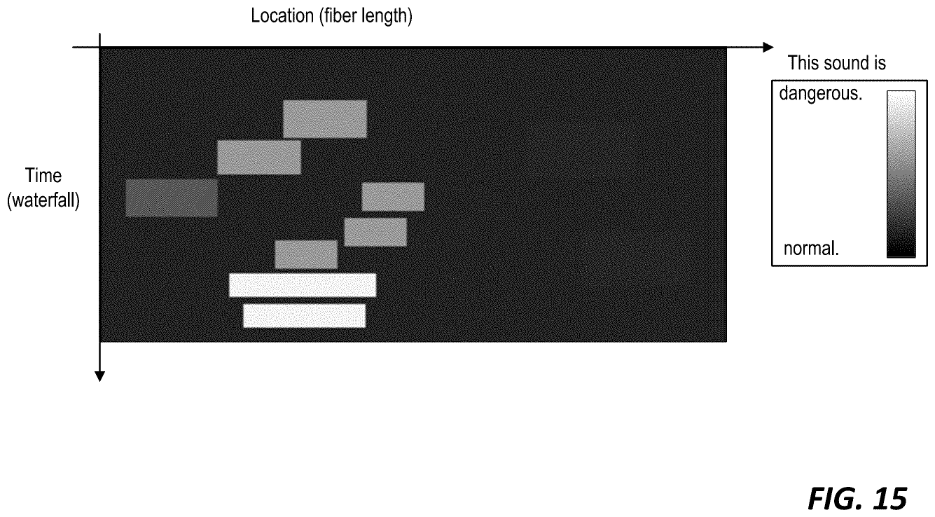

In the Prompt Generator, Large-Scale Language Models (LLMs), Such as Generative Pre-Trained Transformers (GPT), are implemented to interpret users' requests and transform them into the appropriate format. FIG. 15 shows an example of prompt generation from a user's request, described in sentences for an acoustic-event classification task. The free-format text information is input into an LLM with adding a hidden prompt to get prompts for the text encoder in the acoustic-language model. Not only the events to be classified but also additional environmental information can effectively enhance the accuracy of classification, as depicted in

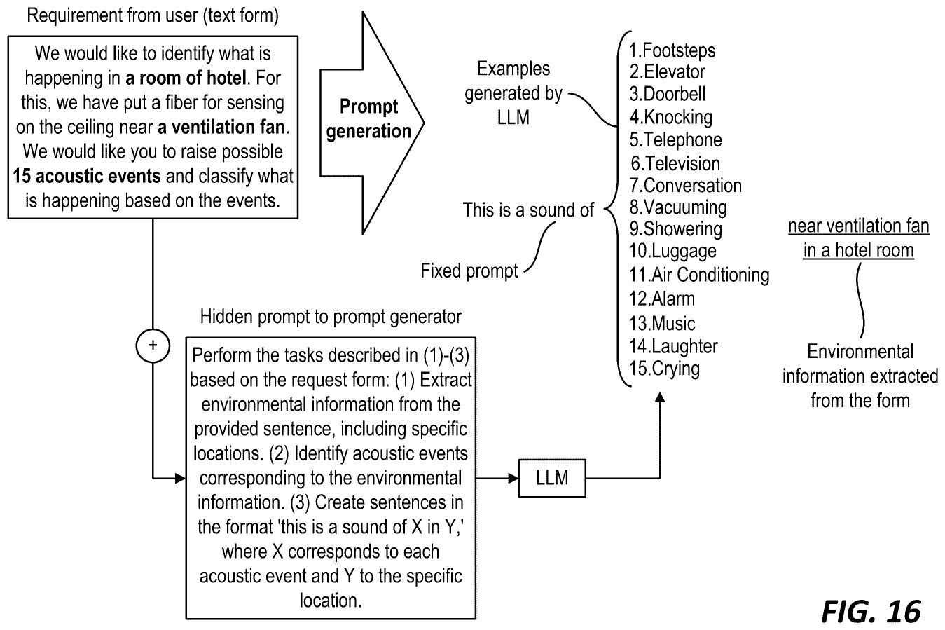

FIG. 16 is a schematic diagram of an illustrative example of prompt generation from user's requests according to aspects of the present disclosure.

After getting the correct-form prompts, they are inputted into the text encoder.

(6-1-2) Prompt Tuning with Tunable Soft Prompts.

While the text encoders prompts can be generated in the manner described in (6-1-1), it needs the prompt engineering in the hidden prompts to maximize the feasibility of the recognition system in specific domains. Consequently, users may need to submit domain-specific texts for their tasks accordingly. To input the optimum prompts without additional efforts from users, the system also requires the flexibility to introduce tunable soft prompts either before or after processing through the prompt generator.

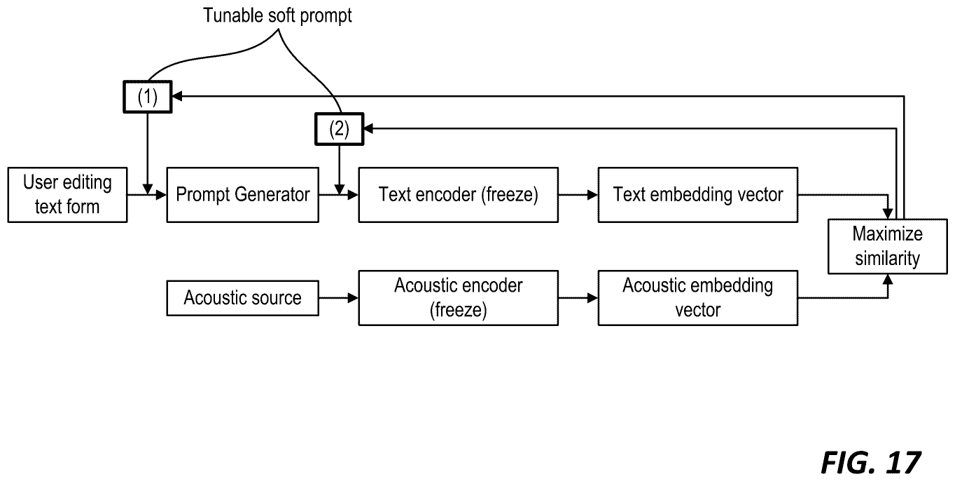

FIG. 17 is a schematic diagram showing illustrative prompt-tuning based language-model update for generating optimum prompts according to aspects of the present disclosure.

This figure illustrates one example of implementing this mechanism, where texts from users, along with attachable soft prompts at either point (1) (before processing users' texts) or point (2) (after processing users' texts), are fed into the LLM prompt generator. The soft prompts, initially a fixed-length sequence of vectors, are subsequently tuned. The generated prompts, combined with the soft prompts, enters a frozen text encoder and is transformed into a text embedding vector. Simultaneously, an acoustic source is encoded by the acoustic encoder, resulting in an acoustic embedding vector. By freezing all parameters except the soft prompts, the system can update the soft prompts at point (1) or (2) to maximize the similarity between the text and acoustic embeddings.

(6-1-2) Prompt Tuning with Tunable Soft Prompts.

While the text encoders prompts can be generated in the manner described in (6-1-1), it needs the prompt engineering in the hidden prompts to maximize the feasibility of the recognition system in specific domains. Consequently, users may need to submit domain-specific texts for their tasks accordingly. To input the optimum prompts without additional efforts from users, the system also requires the flexibility to introduce tunable soft prompts either before or after processing through the prompt generator. FIG. 17 illustrates one example of implementing this mechanism, where texts from users, along with attachable soft prompts at either point (1) (before processing users' texts) or point (2) (after processing users' texts), are fed into the LLM prompt generator. The soft prompts, initially a fixed-length sequence of vectors, are subsequently tuned. The generated prompts, combined with the soft prompts, enters a frozen text encoder and is transformed into a text embedding vector. Simultaneously, an acoustic source is encoded by the acoustic encoder, resulting in an acoustic embedding vector. By freezing all parameters except the soft prompts, the system can update the soft prompts at point (1) or (2) to maximize the similarity between the text and acoustic embeddings.

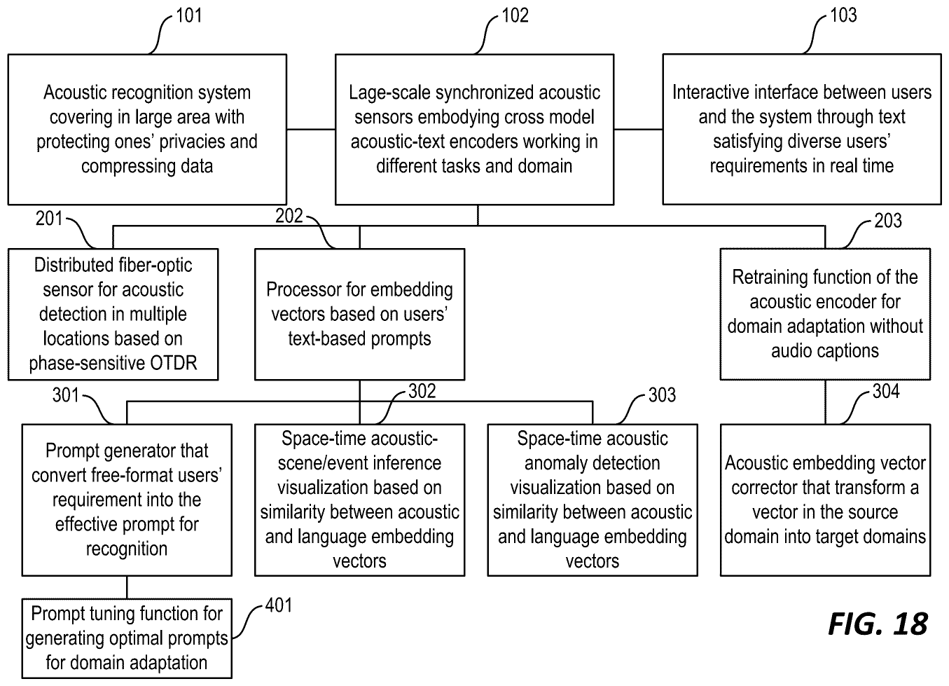

FIG. 18 is a schematic diagram showing illustrative features in hierarchical format according to aspects of the present disclosure.

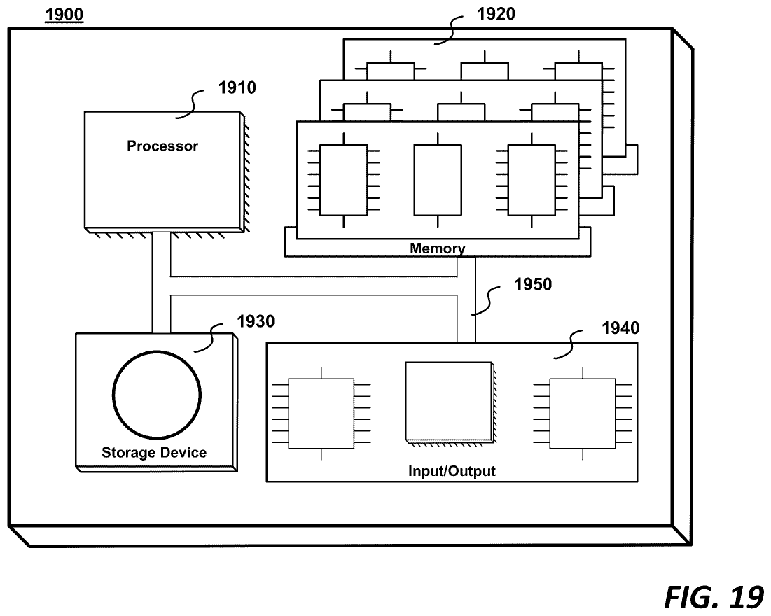

FIG. 19 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 1900 as stored program control instructions.

Computer system 1900 includes processor 1910, memory 1920, storage device 1930, and input/output structure 1940. One or more input/output devices may include a display 1945. One or more busses 1950 typically interconnect the components, 1910, 1920, 1930, and 1940. Processor 1910 may be a single or multi core. Additionally, the system may include accelerators etc., further comprising the system on a chip.

Processor 1910 executes instructions in which embodiments of the present disclosure may comprise steps described in one or more of the Drawing figures. Such instructions may be stored in memory 1920 or storage device 1930. Data and/or information may be received and output using one or more input/output devices.

Memory 1920 may store data and may be a computer-readable medium, such as volatile or non-volatile memory. Storage device 1930 may provide storage for system 1900 including for example, the previously described methods. In various aspects, storage device 1930 may be a flash memory device, a disk drive, an optical disk device, or a tape device employing magnetic, optical, or other recording technologies.

Input/output structures 1940 may provide input/output operations for system 1900.

As those skilled in the art will readily appreciate, benefits of our inventive systems and methods and interactive processes include at least the following.

While we have presented our inventive concepts and description using specific examples, our invention is not so limited. Accordingly, the scope of our invention should be considered in view of the following claims.

1. A large-scale acoustic recognition system comprising:
an acoustic signal collector including a distributed fiber optic sensing (DFOS) system configured to collect acoustic signals from multiple locations as raw signals;
signal preprocessors configured to process the raw signals and convert them into acoustic features; and
an acoustic language model configured to recognize the acoustic features.

2. The system of claim 1 further comprising a vector database configured to post process embedding vectors generated by the acoustic language model.

3. The system of claim 2 further comprising a graphical user interface configured to enable text input into the acoustic language model.

4. The system of claim 3 further comprising a prompt generator configured to convert user-provided text information into formatted prompts for input into the acoustic language model.

5. The system of claim 4 wherein the prompt generator comprises a language model configured to interpret user-provided requests and tune prompts with soft prompts in specific environments.

6. The system of claim 5 wherein the signal preprocessors are configured to filter, denoise, and correct frequency responses.

7. The system of claim 6 wherein the acoustic language model includes an acoustic encoder and a text encoder that are pretrained in a cross-model manner.

8. The system of claim 7 wherein the acoustic language model includes model parameters in the acoustic encoder that are updated to adapt to different domains using arbitrary web-based sound data sets with recorded noise and/or impulse information.

9. The system of claim 8, wherein the embedding vectors are used to perform similarity evaluation between embedded vectors.

10. The system of claim 9, wherein the graphical user interface enables text input using methods including chat boxes, text boxes, and event-class editors and displays outcomes of recognition processes.

11. The system of claim 10, wherein the acoustic encoder is fine-tuned without using labels or captions.

12. The system of claim 11, wherein the prompt generator includes one or more language models to interpret user requests.

13. The system of claim 12, wherein the language models include generative pre-trained transformers (GPT).
